(19) United States
(12) Patent Application Publication
(10) Pub. No.: US 2011/0231445 A1
(43) Pub. Date: Sep. 22, 2011

(54) METHOD, APPARATUS, AND SYSTEM FOR INFORMATION SHARING WITHIN A SOCIAL NETWORK

(76) Inventor: Keith Edward Bourne, Ann Arbor, MI (US)

(21) Appl. No.: 12/724,755

(22) Filed: Mar. 16, 2010

(51) Int. Cl. G06F 17/30; G06F 15/16

(52) U.S. Cl. 707/780; 709/204; 707/E17.014; 707/E17.032

(57) ABSTRACT

A method for sharing a central knowledge base across social networks, the method comprising: allowing a user to generate a piece of information and store it on a server; allowing the user to merge pieces of information into one or more collections of information which are saved on one or more servers; allowing the user to access other pieces and collections of information which are stored on one or more servers; enabling the user to request automated updates of pieces and collections of information which are stored on one or more servers; allowing the user to restrict modifications to information which he generated and which is stored on one or more servers; and allowing the user to modify pieces and collections of information which were generated by other users and are stored on one or more servers, where permission to modify the information has been granted by the first user to generate the information.

### CROSS-REFERENCE TO RELATED APPLICATIONS

None.

### FIELD OF THE INVENTION

The present disclosure is in the technical field of information sharing. More particularly, the present disclosure is in the technical field of information sharing within a social network.

### BACKGROUND OF THE INVENTION

Online social networks, such as Facebook®, exist for sharing information. The social networks contain user generated content which is shared with other members within the respective social networks.

### BRIEF SUMMARY OF THE INVENTION

The present disclosure describes a method for sharing pieces of knowledge from a central knowledge base across social networks. The method allows a user to generate a piece of information, hereinafter known as a knowledge-bit or k-bit. The k-bit can be original, derived from existing information, or a copy of existing information. One or more k-bits can be used to create a collection of information, hereinafter known as a knowledge-bin or k-bin. K-bits and k-bins can be shared between users through one or more social networks. The user can subscribe to a feed which provides updates related to a particular k-bit or k-bin. The user may or may not be able to add content to a particular k-bit or k-bin.

The method for sharing pieces of knowledge from a central knowledge base across social networks comprises: allowing a user to generate a piece of information and store it on a server; allowing the user to merge pieces of information into one or more collections of information which are saved on one or more servers which service one or more social networks; allowing the user to access other pieces and collections of information which are stored on one or more servers; enabling the user to request automated updates of pieces and collections of information which are stored on one or more servers; allowing the user to restrict modifications to information which he generated and which is stored on one or more servers; and allowing the user to modify and track pieces and collections of information which were generated by other users and are stored on one or more servers, where permission to modify the information has been granted by the first user to generate the information.

Tracking a piece or collection of information is accomplished using a unique identifier which is assigned to the piece or collection of information. The identifier can be tracked across social networks via different servers. Tracking enables the user to determine the number of times that a piece or collection of information has been accessed, viewed, and who has potential access to the piece or collection of information.

The method for sharing a central knowledge base across social networks optionally includes the ability to search through the central knowledge base with a user-configurable search algorithm. The user can configure the search algorithm by assessing values to parameters which represent different search methods. If the user chooses not to configure the search algorithm, a default value set for the parameters is used. The most popular value set(s) chosen by other users is used to determine the default value set. Hence, users can search for, subscribe to, and modify k-bit and k-bin feeds as they wish.

A plurality of advertising options are available. Advertisers can choose to target advertising using demographics, k-bits, k-bins, type of organizations, type of groups, categories, and the like. Advertisers may also crawl a user's knowledge base for advertising, rather than the content on individual webpages. Hence, an advertising context is generated which is based upon the knowledge base of the user. Advertisers can bid on keywords that appear in user knowledge bases. Also, time (i.e. the age of a piece or collection of information) can be a factor in determining whether or not advertising context is related to a particular keyword.

The advertising context is also based upon the user's social networks. The user's social networks are analyzed for common interests, common background characteristics of users within their social network, affiliation to groups, affiliation to organizations, and the like. Advertisers can use the advertising context to selectively determine where advertising is placed.

In one embodiment, an optional advertising rating system is included which allows the user to provide advertising feedback. The advertising feedback helps advertisers determine advertising effectiveness.

In one embodiment, a user image stays with content that the user has generated, even if it has been copied to a different user's knowledge base. Hence, a user brand related to specific k-bits and k-bins can be established.

In one embodiment, a user can add the information flowing to their knowledge base that comes from a Really Simple Syndication (RSS) feed with one-click and without any technical knowledge of what an RSS feed is or how to subscribe to one. Information flowing from any outside feed can be filtered by keyword.

In another embodiment, a user can to track views of their k-bits/k-bins and if those kbits/kbins are copied into other user's knowledge bases. Users provide demographic info and this is used to generate reports about the backgrounds of the users that are interested in and willing to copy this users k-bits/k-bins.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

### BRIEF DESCRIPTION OF THE DRAWINGS

FIG. 1 is a flowchart illustrating a method for sharing a central knowledge base across social networks according to an embodiment of the present disclosure.

FIG. 2 is a block diagram of a typical computer system used for implementing embodiments of the present disclosure.

### DETAILED DESCRIPTION OF THE INVENTION

Social networks allow users to post pieces of information. The pieces of information are not typically organized into collections of knowledge. Rather, the pieces of information expand into conversation threads which don't assemble the knowledge into an easily referenced collection.

An alternative method for organizing information is an on-line encyclopedia, such as Wikipedia®. The on-line encyclopedia allows one or more users to create a collection of knowledge. Approved users can add to or modify the knowledge collections. The end product, when it works, is a useful collection of knowledge which has been reviewed and improved by those skilled in the knowledge being recorded. In essence, Wikipedia® allows users to create a collaboratively formed document.

What is needed is a method which combines elements of social networking with an on-line encyclopedia. Users could take information from Wikipedia® and other sources to form collaborative collections of documents and information. The collaborative collections should be more easily distributable, more easily shared across networks, and capable of being organized in new and different ways.

The present disclosure describes a method for sharing pieces of knowledge from a central knowledge base across social networks. The method allows a user to generate a piece of information, hereinafter known as a knowledge-bit or k-bit. The k-bit can be original, derived from existing information, or a copy of existing information. One or more k-bits can be used to create a collection of information, hereinafter known as a knowledge-bin or k-bin. K-bits and k-bins can be shared between users through one or more social networks. The user can subscribe to a feed which provides updates related to a particular k-bit or k-bin. The user may or may not be able to add content to a particular k-bit or k-bin.

The method for sharing pieces of knowledge from a central knowledge base across social networks comprises: allowing a user to generate a piece of information and store it on a server; allowing the user to merge pieces of information into one or more collections of information which are saved on one or more servers; allowing the user to access other pieces and collections of information which are stored on one or more servers which service one or more social networks; enabling the user to request automated updates of pieces and collections of information which are stored on one or more servers; allowing the user to restrict modifications to information which he generated and which is stored on one or more servers; and allowing the user to modify and track pieces and collections of information which were generated by other users and are stored on one or more servers, where permission to modify the information has been granted by the first user to generate the information.

Tracking a piece or collection of information is accomplished using a unique identifier which is assigned to the piece or collection of information. The identifier can be tracked across social networks via different servers. Tracking enables the user to determine the number of times that a piece or collection of information has been accessed, viewed, and who has potential access to the piece or collection of information.

The method for sharing a central knowledge base across social networks optionally includes the ability to search through the central knowledge base with a user-configurable search algorithm. The user can configure the search algorithm by assessing values to parameters which represent different search methods. If the user chooses not to configure the search algorithm, a default value set for the parameters is used. The most popular value set(s) chosen by other users is used to determine the default value set. Hence, users can search for, subscribe to, and modify k-bit and k-bin feeds as they wish.

A plurality of advertising options are available. Advertisers can choose to target advertising using demographics, k-bits, k-bins, type of organizations, type of groups, categories, and the like. Advertisers may also crawl a user's knowledge base for advertising, rather than the content on individual webpages. Hence, an advertising context is generated which is based upon the knowledge base of the user. Advertisers can bid on keywords that appear in user knowledge bases. Also, time (i.e. the age of a piece or collection of information) can be a factor in determining whether or not advertising context is related to a particular keyword.

The advertising context is also based upon the user's social networks. The user's social networks are analyzed for common interests, common background characteristics of users within their social network, affiliation to groups, affiliation to organizations, and the like. Advertisers can use the advertising context to selectively determine where advertising is placed.

In one embodiment, an optional advertising rating system is included which allows the user to provide advertising feedback. The advertising feedback helps advertisers determine advertising effectiveness.

In one embodiment, a user image stays with content that the user has generated, even if it has been copied to a different user's knowledge base. Hence, a user brand related to specific k-bits and k-bins can be established.

In one embodiment, a user can add the information flowing to their knowledge base that comes from a Really Simple Syndication (RSS) feed with one-click and without any technical knowledge of what an RSS feed is or how to subscribe to one. Information flowing from any outside feed can be filtered by keyword.

In another embodiment, a user can to track views of their k-bits/k-bins and if those kbits/kbins are copied into other user's knowledge bases. Users provide demographic info and this is used to generate reports about the backgrounds of the users that are interested in and willing to copy this users k-bits/k-bins.

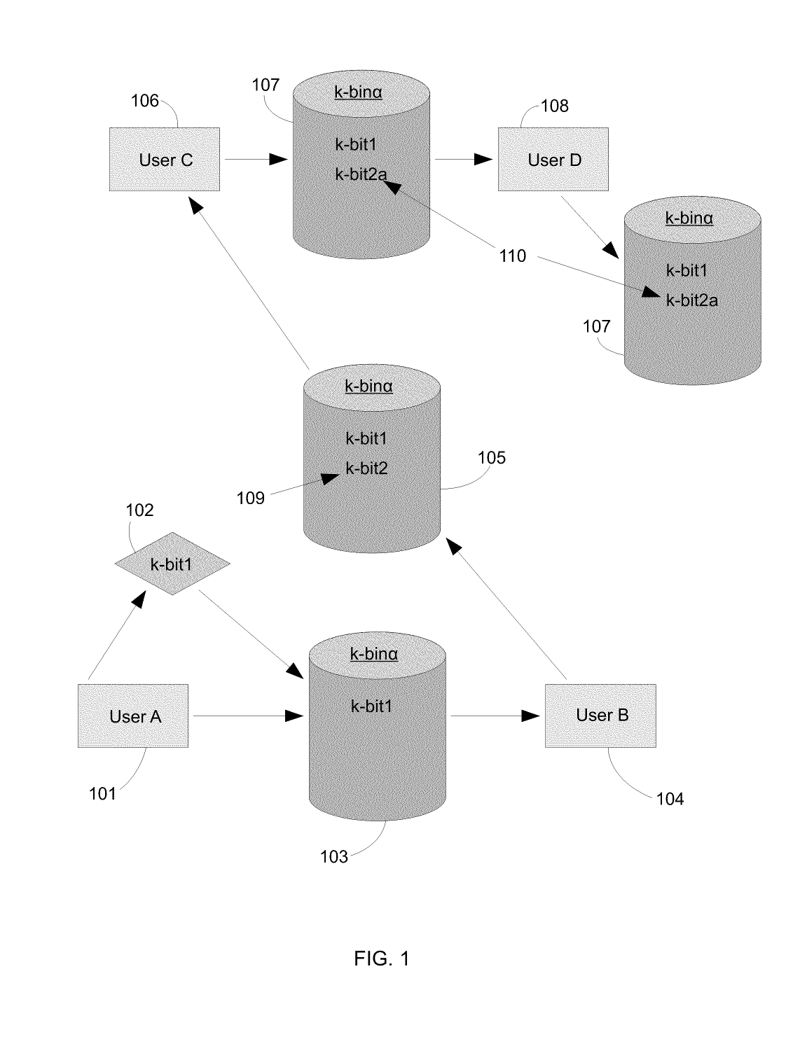

FIG. 1 is a diagram illustrating a method for sharing a central knowledge base across social networks according to an embodiment of the present disclosure. User A 101 generates k-bit1 102. User A 101 then generates k-binα 103 and incorporates k-bit1 102 into k-bins 103. User B 104 reads k-binα 103 and adds k-bit2 109 to create k-binα 105. User C 106 reads k-binα 105 and modifies k-bit2 109 within k-binα 105 to create k-bit2a 110 within k-binα 107. Finally, User D 108 reads k-binα 107 and makes no changes.

In the FIG. 1 embodiment, the users have the ability to track the k-bits. For example, User A 101 can track k-bit1 102 and link it to the backgrounds of the users that have copied it. This includes situations where k-bit1 102 has been added to a k-bin. In a separate embodiment, k-bit2 109 can be tracked after it has been modified to k-bit2a 110.

A practical example of k-bit tracking is a situation where a researcher posts a k-bit about solar cells. The researcher may find that the k-bit was incorporated into k-bins with 3 users in the construction industry and 10 users in the auto industry. The tracking capability provides more context to the researcher regarding the people interested in his industry, and may allow him to tailor his k-bits more effectively.

Note that while FIG. 1 shows a sequence of events, implying a daisy chain data configuration, the data is actually shared using a star configuration. K-bin data is sent to all users authorized for the k-bin data concurrently from a central server or servers, which maintain the data. Any changes to k-bin data are made via communication with the central server or servers and updated k-bin data is then sent to all users authorized for the updated k-bin data.

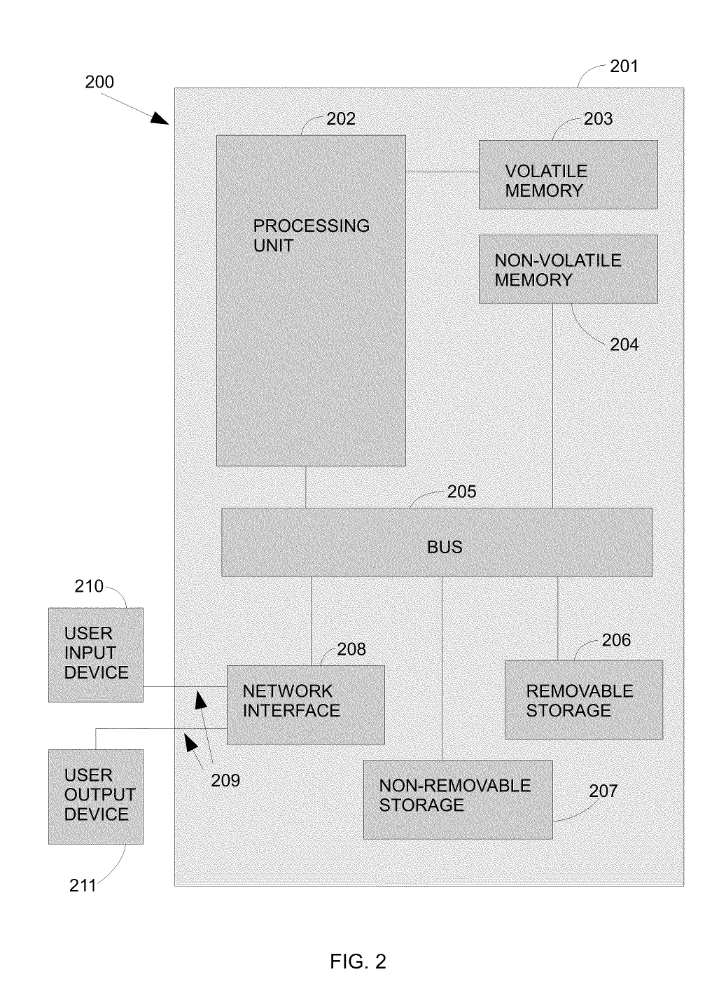

FIG. 2 is a block diagram of a typical computer system used for implementing embodiments of the present disclosure. FIG. 2 and the following discussion are intended to provide a brief, general description of a suitable computing environment in which certain embodiments of the present disclosure may be implemented.

FIG. 2 shows a computing environment 200, which can include but is not limited to, a housing 201, processing unit 202, volatile memory 203, non-volatile memory 204, a bus 205, removable storage 206, non-removable storage 207, a network interface 208, ports 209, a user input device 210, and a user output device 211.

In one embodiment, the system may be implemented in a non-networked setting. That is, the system consists of a server/client model.

Various embodiments of the present subject matter can be implemented in software, which may be run in the environment shown in FIG. 2 or in any other suitable computing environment. The embodiments of the present subject matter are operable in a number of general-purpose or special-purpose computing environments. Some computing environments include personal computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments, and the like to execute code stored on a computer readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

A computer may include or have access to a computing environment that includes one or more user input modules, one or more user output modules, and one or more communication connections such as a network interface card or a USB connection. The one or more output devices can be a display device of a computer, computer monitor, TV screen, plasma display, LCD display, display on a digitizer, display on an electronic tablet, and the like. The computer may operate in a networked environment using the communication connection to connect one or more remote computers. A remote computer may include a personal computer, server, router, network PC, a peer device or other network node, and/or the like. The communication connection may include a Local Area Network (LAN), a Wide Area Network (WAN), and/or other networks.

Memory may include volatile memory and non-volatile memory. A variety of computer-readable media may be stored in and accessed from the memory elements of a computer, such as volatile memory and non-volatile memory, removable storage and non-removable storage. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, memory sticks, and the like. Memory elements may also include chemical storage, biological storage, and other types of data storage.

“Processor” or “processing unit” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, an explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc. for performing tasks, or defining abstract data types or low-level hardware contexts.

For the purposes of this disclosure, RSS is defined as a family of web feed formats used to publish frequently updated works—such as blog entries, news headlines, audio, and video—in a standardized format. An RSS document (which is called a “feed”, “web feed”, or “channel”) includes full or summarized text, plus meta data such as publishing dates ad authorship. A standardized XML file format allows the information to be published once and viewed by many different programs. The user subscribes to a feed by entering into a reader the feed's URL or by clicking an icon in a web browser that initiates the subscription process.

While the present invention has been described herein with reference to an embodiment and various alternatives thereto, it should be apparent that the invention is not limited to such embodiments. Rather, many variations would be apparent to persons of skill in the art without departing from the scope and spirit of the invention, as defined herein and in the claims.

I claim:

1. A method for sharing a central knowledge base across social networks, the method comprising:
allowing a user to generate a piece of information and store it on a server;
allowing the user to merge pieces of information into one or more collections of information which are saved on one or more servers which service one or more social networks;
allowing the user to access other pieces and collections of information which are stored on one or more servers;
enabling the user to request automated updates of pieces and collections of information which are stored on one or more servers;
allowing the user to restrict modifications to information which he generated and which is stored on one or more servers; and
allowing the user to modify and track pieces and collections of information which were generated by other users and are stored on one or more servers, where permission to modify the information has been granted by the first user to generate the information.

2. The method of claim 1, further comprising:
having the ability to search through the central knowledge base with a user-configurable search algorithm.

3. The method of claim 2, wherein the user-configurable search algorithm is generated by assessing values to parameters which represent different search methods.

4. The method of claim 3, wherein a default value set for the parameters is used.

5. The method of claim 1, further comprising:
allowing an advertiser to access a user's knowledge base for advertising purposes.

6. The method of claim 1, further comprising:
allowing a user image to stay with content that the user has generated.

7. An article comprising:
a storage medium having instructions that, when executed by a computing platform, result in execution of a method for sharing a central knowledge base across social networks, comprising:
allowing a user to generate a piece of information and store it on a server;
allowing the user to merge pieces of information into one or more collections of information which are saved on one or more servers which service one or more social networks;
allowing the user to access other pieces and collections of information which are stored on one or more servers;
enabling the user to request automated updates of pieces and collections of information which are stored on one or more servers;
allowing the user to restrict modifications to information which he generated and which is stored on one or more servers; and
allowing the user to modify and track pieces and collections of information which were generated by other users and are stored on one or more servers, where permission to modify the information has been granted by the first user to generate the information.

8. The article of claim 7, further comprising:
having the ability to search through the central knowledge base with a user-configurable search algorithm.

9. The article of claim 8, wherein the user-configurable search algorithm is generated by assessing values to parameters which represent different search methods.

10. The article of claim 9, wherein a default value set for the parameters is used.

11. The article of claim 7, further comprising:
allowing an advertiser to access a user's knowledge base for advertising purposes.

12. The article of claim 7, further comprising:
allowing a user image to stay with content that the user has generated.

13. A computer system comprising:
a computer network, wherein the computer network has a plurality of network elements, each network element comprising:
a network interface;
an input module coupled to the network interface that receives topology data via the network interface;
a processing unit; and
a memory coupled to the processor, the memory having stored therein code associated with sharing a central knowledge base across social networks, comprising:
allowing a user to generate a piece of information and store it on a server;
allowing the user to merge pieces of information into one or more collections of information which are saved on one or more servers which service one or more social networks;
allowing the user to access other pieces and collections of information which are stored on one or more servers;
enabling the user to request automated updates of pieces and collections of information which are stored on one or more servers;
allowing the user to restrict modifications to information which he generated and which is stored on one or more servers; and
allowing the user to modify and track pieces and collections of information which were generated by other users and are stored on one or more servers, where permission to modify the information has been granted by the first user to generate the information.

14. The system of claim 13, further comprising:
having the ability to search through the central knowledge base with a user-configurable search algorithm.

15. The system of claim 14, wherein the user-configurable search algorithm is generated by assessing values to parameters which represent different search methods.

16. The system of claim 15, wherein a default value set for the parameters is used.

17. The system of claim 13, further comprising:
allowing an advertiser to access a user's knowledge base for advertising purposes.

18. The system of claim 13, further comprising:
allowing a user image to stay with content that the user has generated.
